(19) United States
(12) Patent Application Publication
(10) Pub. No.: US 2014/0313772 A1
(43) Pub. Date: Oct. 23, 2014

(54) ILLUMINATION DEVICE, AND DISPLAY DEVICE PROVIDED THEREWITH

(71) Applicant: Sharp Kabushiki Kaisha, Osaka (JP)

(72) Inventor: Kentaro Kamada, Osaka (JP)

(73) Assignee: Sharp Kabushiki Kaisha, Osaka (JP)

(21) Appl. No.: 14/354,079

(22) PCT Filed: Oct. 19, 2012
(86) PCT No.: PCT/JP2012/077040

§ 371 Date: Apr. 24, 2014

(30) Foreign Application Priority Data
Oct. 26, 2011 (JP) 2011-234822

(51) Int. Cl. F21V 8/00

(52) U.S. Cl. CPC G02B 6/0033
USPC 362/611

(57) ABSTRACT

An illumination device capable of increasing the luminance of an entire screen is provided. In this illumination device (10), a plurality of scattering dots (12e) are disposed on a light guide plate (12), and a plurality of high-luminance center points (intersections (O1)) are arranged in a matrix at prescribed intervals on the light guide plate. The density of the scattering dots in areas (S1a), the center of which is the high-luminance center point, is higher than the density of the scattering dots in an area (S1b) outside the areas (S1a).

### TECHNICAL FIELD

The present invention relates to an illumination device and a display device provided therewith, and particularly relates to an illumination device having a light guide plate on which light from a light source is incident and a display device provided therewith.

### BACKGROUND ART

A liquid crystal display device (a display device) equipped with a non light emitting display panel (a member to be illuminated) typically has a backlight device (an illumination device) that illuminates the display panel. A backlight device having a plurality of LEDs (light sources) and a light guide plate on which light from these LEDs is radiated is known as such a backlight device.

FIGS. 12 and 13 show an example of a conventional display device configuration provided with LEDs and a light guide plate. As shown in FIG. 12, a display device 1001 is provided with a display panel (a member to be illuminated) 1002 and a backlight device (illumination device) 1010 that illuminates this display panel 1002. The backlight device 1010 includes a plurality of LEDs (light sources) 1011, a light guide plate 1012 on which light from these LEDs 1011 is radiated, a plurality of optical sheets 1013 arranged near a light-exiting surface 1012a of the light guide plate 1012, a reflective sheet 1014 arranged near a rear surface 1012b of the light guide plate 1012, and a chassis 1015 that houses these.

The light guide plate 1012 has the light-exiting surface 1012a that is the widest surface of the light guide plate 1012 and that is disposed on the display panel 1002 side, the rear surface 1012b disposed on the side opposite to the light-exiting surface 1012a, light-receiving side faces 1012c arranged facing the respective LEDs 1011, and side faces 1012d (see FIG. 13) that extend in a direction (the B direction) parallel with the respective light-receiving side faces 1012c.

As shown in FIG. 13, the light-exiting surface 1012a of the light guide plate 1012 has a plurality of scattering dots 1012e that change the direction of light that has entered the light- receiving side faces 1012c and thereby cause this light to be emitted towards the display panel 1002 from the light-exiting surface 1012a.

In a liquid crystal display device, the luminance specification is often based on the luminance of the center of the screen, for example; thus, it is possible to improve the luminance at the center of the screen. Therefore, in the backlight device 1010, the scattering dots 1012e in the center area of the light guide plate 1012 are arranged at a closer pitch than the scattering dots 1012e in other areas. This makes it possible to increase the luminance of the center of the screen.

A display device with scattering dots arranged at a close pitch in the center area of a light guide plate is disclosed in Patent Document 1, for example.

### RELATED ART DOCUMENT

### Patent Document

Patent Document 1: Japanese Patent Application Laid-Open Publication No. 2008-286955 (pages 9 and 10, FIG. 6)

### SUMMARY OF THE INVENTION

### Problem to be Solved by the Invention

However, in the display device 1001 of the conventional example, while the luminance of the screen center can be increased, the luminance of the screen periphery will decrease. Therefore, in the configuration of the display device 1001, it is difficult to increase the luminance of the entire screen.

The present invention was made to solve the above-mentioned problems, and aims at providing an illumination device that can increase the luminance of the entire screen and a display device provided therewith.

### Means for Solving the Problems

To achieve the above-mentioned aims, an illumination device of the present invention includes: a light source; and a light guide plate having a light-receiving side face on which light from the light source is incident, a light-exiting surface where light exits towards a member to be illuminated, and a rear surface opposite to the light-exiting surface, wherein a plurality of scattering dots are distributed on the light-exiting surface or the rear surface of the light guide plate, the scattering dots scattering light that has entered the light-receiving side face and the light exiting from the light-exiting surface, wherein a plurality of high-luminance center points are defined in a matrix at prescribed intervals on the light guide plate, wherein the light-exiting surface or the rear surface of the light guide plate has first areas having one of the high-luminance center points at a center thereof and a second area that includes all areas except the first areas, and wherein a density of the scattering dots in the first areas is higher than a density of the scattering dots in the second area.

In this illumination device, as described above, the plurality of high-luminance center points are arranged in a matrix at prescribed intervals on the light guide plate, and the density of the scattering dots in the first areas, which have one of the high-luminance center points as the center thereof, is higher than the density of the scattering dots in the second area outside the first areas. This makes it possible for more light to exit from the first areas than from the second area. Therefore, the luminance of the plurality of high-luminance center points arranged in a matrix on the light guide plate can be increased. Thus, the luminance of not just the screen center, but the entire screen can be increased. Furthermore, the uniformity of screen luminance can be improved. Even if the entire light guide plate does not have uniformly high luminance, similar viewing effects can be achieved by merely making several spots have high luminance.

In the above-mentioned illumination device, it is preferable that an area of the light guide plate corresponding to a display area of the member to be illuminated have two long sides facing each other and two short sides facing each other, that the area of the light guide plate corresponding to the display area be evenly divided into three sections in both a long side direction and a short side direction of the light guide plate to form nine areas, one of the high-luminance center points being disposed in each of these areas. With this configuration, it is possible to increase the luminance of the entire screen with ease and allow an improvement in the uniformity of screen luminance.

In this case, it is preferable that the high-luminance center points be respectively located at intersection locations of three first lines and three second lines, that a length of the long sides of the light guide plate be H and a length of the short sides of the light guide plate be V, that the first lines be lines that are H/n from the short sides of the light guide plate towards an inside thereof, that the second lines be lines that are V/n from the long sides of the light guide plate towards the inside thereof, and that n be 2, 6, or 9. With this configuration, when the luminance on the intersections is used to calculate the luminance of the display device, the luminance of the entire screen can be effectively increased and the uniformity of screen luminance be effectively improved.

In the above-mentioned illumination device, it is preferable that the scattering dots in the first areas have a larger outer shape than the scattering dots in the second area. With this configuration, the density of the scattering dots in the first area can be made higher than the density of the scattering dots in the second area with ease.

In the above-mentioned illumination device, it is preferable that the scattering dots in the first areas be arranged at a smaller pitch than the scattering dots in the second area. With this configuration, the density of the scattering dots in the first areas can be made higher than the density of the scattering dots in the second area with ease.

In the above-mentioned illumination device, it is preferable that the scattering dots include recesses and protrusions formed in the light-exiting surface or the rear surface of the light guide plate. With this configuration, the scattering dots can be provided with ease.

Recesses and protrusions is a concept including a configuration with only recesses or a configuration with only protrusions.

In the above-mentioned illumination device, it is preferable that scattering dots include a reflective layer disposed on the rear surface of the light guide plate. With this configuration, the scattering dots can be provided with ease.

In the illumination device in which the scattering dots in the first areas have a larger outer shape than the scattering dots in the second area, it is preferable that the scattering dots in the first areas have a diameter that is less than or equal to three times a diameter of each of the scattering dots in the second area.

A display device of the present invention includes the illumination device having the configurations described above, and a display panel illuminated by the illumination device. With this configuration, a display device capable of increasing the luminance of the entire screen can be obtained.

### Effects of the Invention

As described above, according to the present invention, an illumination device that can increase the luminance of the entire screen and a display device provided therewith can be obtained with ease.

### BRIEF DESCRIPTION OF THE DRAWINGS

FIG. 1 is a cross-sectional view of a display device according to Embodiment 1 of the present invention.

FIG. 2 is a view of a light guide plate and light sources of Embodiment 1 of the present invention shown in FIG. 1.

FIG. 3 is a cross-sectional view of the scattering dots on the light guide plate of Embodiment 1 of the present invention shown in FIG. 1.

FIG. 4 is a cross-sectional view of the scattering dots on the light guide plate of Embodiment 1 of the present invention shown in FIG. 1.

FIG. 5 is a cross-sectional view of the scattering dots on the light guide plate of Embodiment 1 of the present invention shown in FIG. 1.

FIG. 6 is a view of the light guide plate of Embodiment 1 of the present invention shown in FIG. 1.

FIG. 7 is a magnified view of the scattering dots on the light guide plate of Embodiment 1 of the present invention shown in FIG. 1.

FIG. 8 is a view of a light guide plate and light sources of Embodiment 2 of the present invention.

FIG. 9 is a magnified view of scattering dots on the light guide plate of Embodiment 2 of the present invention shown in FIG. 8.

FIG. 10 is a view of a light guide plate and light sources of Embodiment 3 of the present invention.

FIG. 11 is a view of the light guide plate according to a modification example of the present invention.

FIG. 12 is a cross-sectional view of an example of a conventional display device.

FIG. 13 is a plan view of a light guide plate and light source of the example of the conventional display device shown in FIG. 12.

### DETAILED DESCRIPTION OF EMBODIMENTS

Embodiments of the present invention will be explained below with reference to the drawings. For clarity, hatching is not used in some cross-sectional views.

### Embodiment 1

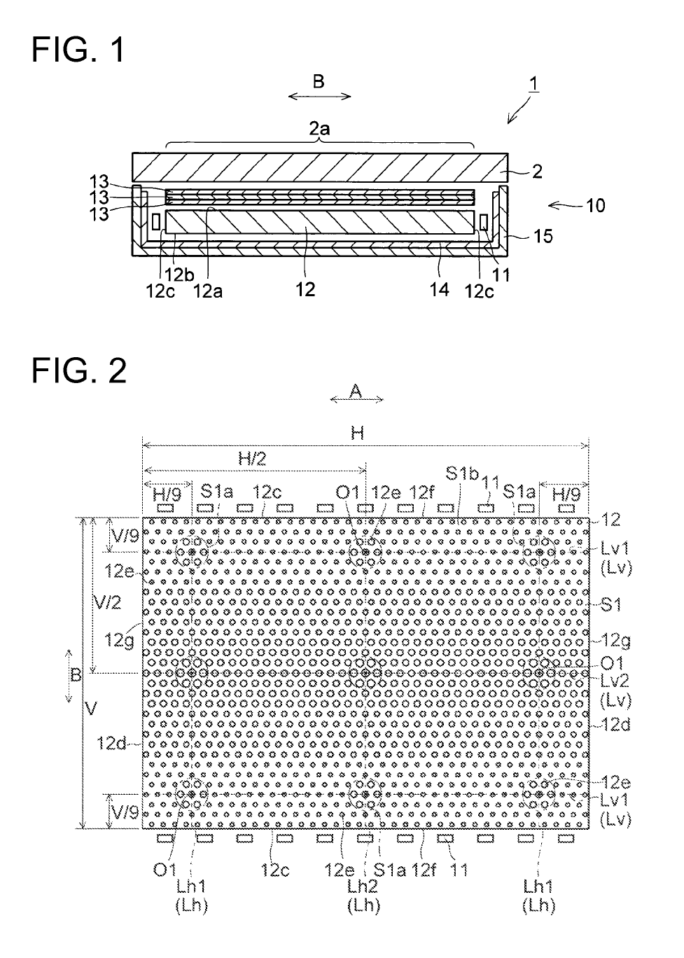

A display device 1 according to Embodiment 1 of the present invention will be explained below with reference to FIGS. 1 to 7.

The display device 1 of Embodiment 1 of the present invention is used in a television receiver and the like, for example. As shown in FIG. 1, the display device 1 includes a display panel 2 (a member to be illuminated), and an illumination device 10 that illuminates the display panel 2, placed on the rear side of the display panel 2. The “rear side” (the bottom in FIG. 1) in the “rear side of the display panel 2” is a directional concept that also applies to other constituting elements.

The display panel 2 is a liquid crystal display panel that has two glass substrates with a liquid crystal layer, which is not shown, interposed therebetween. The display panel 2 displays images by being illuminated by the illumination device 10. A bezel (not shown) is arranged so as to cover the periphery of the display panel 2, and the area of the display panel 2 corresponding to the opening of the bezel serves as a display area 2a.

The illumination device 10 is an edge-lit (also called side-lit) backlight device. The illumination device 10 includes a plurality of light sources 11, a light guide plate 12 that guides light from the light sources 11, a plurality of optical sheets 13 arranged near a light-exiting surface 12a of the light guide plate 12; a reflective sheet 14 arranged on the side of the light guide plate 12 opposite to a rear surface 12b thereof; and a chassis 15 that houses these.

As shown in FIG. 2, the plurality of light sources 11 are arranged facing light-receiving side faces 12c of the light guide plate 12, described later. In other words, the plurality of light sources 11 are arranged along two edges of the light guide plate 12 opposite to each other. The plurality of light sources 11 are arranged in parallel at prescribed intervals along the A direction (the long side direction of the light guide plate 12). The light sources 11 are LEDs, for example, and emit white light.

As shown in FIGS. 1 and 2, the light guide plate 12 is formed in a flat-plate shape. The light guide plate 12 has the light-exiting surface 12a that is the widest surface of the light guide plate 12 and from which planar light is emitted towards the display panel 2, the rear surface 12b that is the side opposite to the light-exiting surface 12a, light-receiving side faces 12c on which light from the light sources 11 is radiated, and side faces 12d that extend in a direction (the B direction, which is the short side direction of the light guide plate 12) orthogonal to (intersecting with) the respective light-receiving side faces 12c. The light guide plate 12 functions to guide light that has entered the light-receiving side faces 12c and to change the direction of the light so that planar light is emitted towards the display panel 2.

The rear surface 12b of the light guide plate 12, for example, has a large number (a plurality) of scattering dots 12e that change the direction of light that has entered the light-receiving side faces 12c and thereby cause this light to be emitted towards the display panel 2 from the light-exiting surface 12a. The scattering dots 12e are arranged in a zigzag pattern, for example, but may be arranged in a pattern other than a zigzag (a matrix, for example). In FIG. 2, for ease of understanding, the number of scattering dots 12e has been reduced and the depiction thereof enlarged.

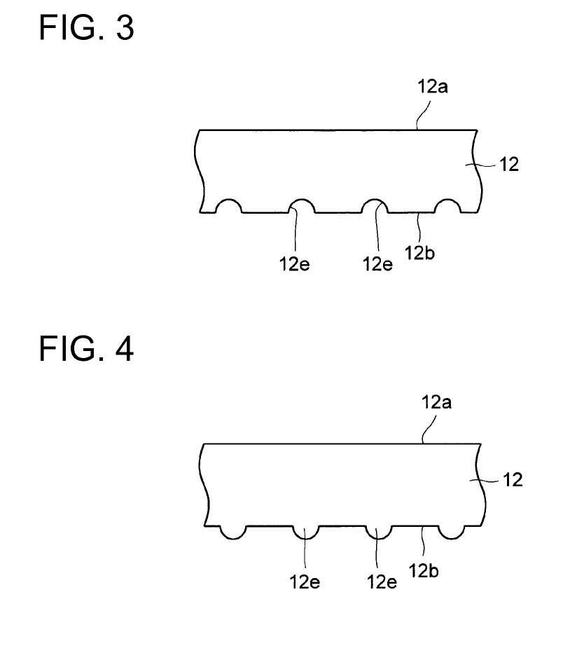

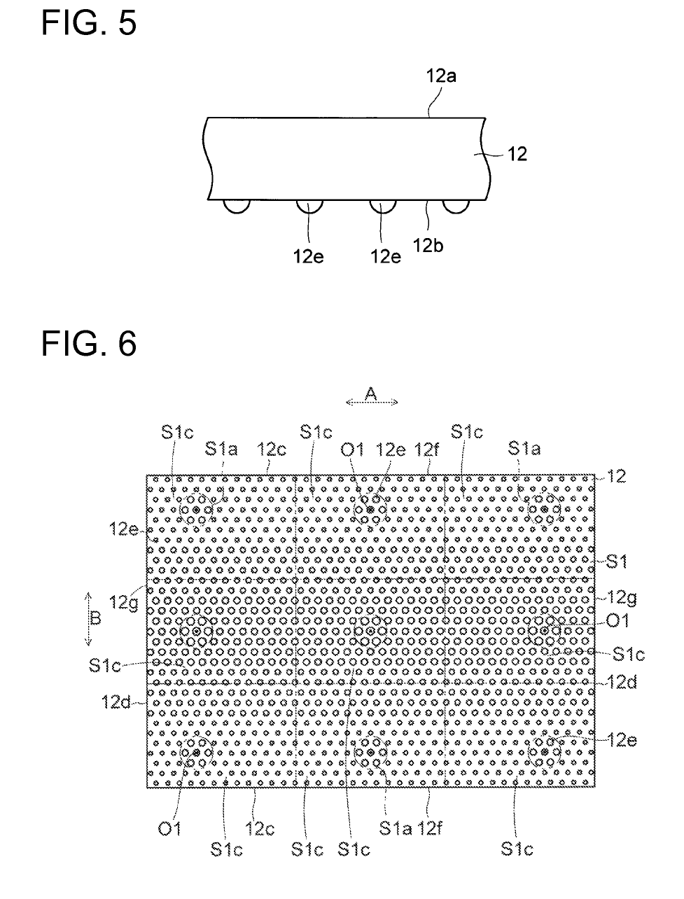

As shown in FIGS. 3 and 4, the scattering dots 12e are recessed portions or protruding portions formed in the rear surface 12b of the light guide plate 12, for example. Although not shown, the scattering dots 12e may be recessed portions or protruding portions formed in the light-exiting surface 12a of the light guide plate 12. The recessed portions or protruding portions may be formed in a semispherical shape, a quadrilateral shape, or other shapes, for example. As shown in FIG. 5, the scattering dots 12e may be a reflective layer disposed on the rear surface 12b of the light guide plate 12. The reflective layer may be formed of white ink or other materials, for example.

The scattering dots 12e have a larger diameter (outer shape) the farther they are from the light sources 11 (towards the inside of the light guide plate 12), except for areas S1a, described later. As shown in FIG. 2, the scattering dots 12e disposed on the areas farthest from the light sources 11 (the center of the light guide plate 12) have a larger diameter (outer shape) than the scattering dots 12e disposed on the areas closest to the light sources 11.

As shown in FIG. 2, the area (directly below the display area 2a) of the light guide plate 12 corresponding to the display area 2a (see FIG. 1) of the display panel 2 is the area S1. In the present embodiment, for ease of explanation, the entirety of the light guide plate 12 is described as being the area S1. The area S1 has a rectangular shape having two long sides 12f and two short sides 12g. In the present embodiment, the light-receiving side faces 12c are the long sides 12f of the area S1, and the side faces 12d are the short sides 12g of the area S1. The long sides 12f of the area S1 have a length H and the short sides 12g have a length V.

The lines that are a distance of H/9 from the short sides 12g towards the inside of the light guide plate are lines Lh1, the line that is a distance of H/2 from the short side 12g towards the inside of the light guide plate is line Lh2, the lines that are a distance of V/9 from the long sides 12f towards the inside of the light guide plate are lines Lv1, and the line that is a distance of V/2 from the long side 12f towards the inside of the light guide plate is line Lv2. The areas S1a are the small areas that are centered around one of nine intersections O1 of the three lines Lh (two lines Lh1 and line Lh2) and three lines Lv (two lines Lv1 and line Lv2), and the area of the area S1 besides the areas S1a is an area S1b. The circular areas surrounded by the dotted line with dashes in FIGS. 2, 6, and 7 are the areas S1a. Lines Lh (lines Lh1 and Lh2) are examples of “first lines” of the present invention, and lines Lv (lines Lv1 and Lv2) are examples of “second lines” of the present invention. The areas S1a are examples of “first areas” of the present invention, and the area S1b is an example of a “second area” of the present invention.

The intersections O1 are arranged in the long side direction and short side direction in a matrix on the light guide plate 12 at prescribed intervals. The intersections O1 are respectively located at the centers of the areas S1a where the scattering dots 12e having the large diameters (outer shapes) are formed, as described later, and these intersections O1 serve as high-luminance center points. As shown in FIG. 6, if the nine areas obtained by respectively dividing the area S1 (the area of the light guide plate 12 corresponding to the display areas 2a of the display panel 2) into three equal sections in the long side direction and three equal sections in the short side direction are areas S1c, then one of the intersections O1 (the high-luminance center points) is arranged in each of the nine areas S1c.

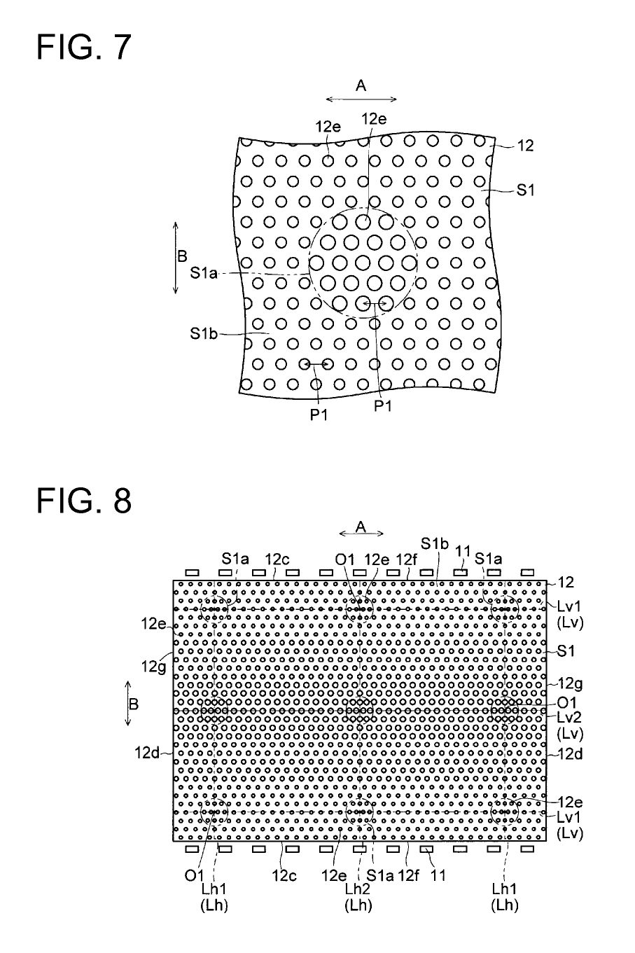

As shown in FIG. 7, the density of the scattering dots 12e in the areas S1a is higher than the density of the scattering dots 12e in the area S1b. Density means the area of the scattering dots 12e per unit area. In the present embodiment, the scattering dots 12e of the areas S1a have a larger diameter (outer shaper) than the scattering dots 12e of the area S1b. It is preferable that the diameter of the scattering dots 12e in the areas S1a be less than or equal to three times the diameter of the scattering dots 12e in the area S1b. The scattering dots 12e in the areas S1a may have a diameter of approximately 0.3 to 1.5 mm, and the scattering dots 12e in the area S1b may have a diameter of approximately 0.1 to 0.5 mm, for example. The scattering dots 12e in the areas S1a and the scattering dots 12e in the area S1b are arranged in parallel at an equal pitch P1 in the A direction.

As shown in FIG. 1, the plurality of optical sheets 13 are a diffusion plate, a prism sheet, a lens sheet, and the like, and function to diffuse light from the light guide plate 12 and concentrate it at a prescribed viewing angle. The diffusion plate, prism sheet, lens sheet, and the like may be provided or not provided as necessary.

The reflective sheet 14 functions to reflect light that has exited from the rear surface 12b of the light guide plate 12 back towards the light guide plate 12.

In the present embodiment, as described above, nine high-luminance center points (intersections O1) are arranged at prescribed intervals in a matrix on the light guide plate 12, and the density of the scattering dots 12e in the areas S1a, which each has one of the high-luminance center points (intersections O1) at the center thereof, is higher than the density of the scattering dots 12e in the area S1b outside the areas S1a. This makes it possible for more light to exit from the areas S1a than from the area S1b. Therefore, the luminance on the display panel 2 at the nine points corresponding to the high-luminance center points (intersections O1) of the light guide plate 12 can be increased. This makes it possible to increase both the luminance of the screen (display area 2a) center and the luminance of the screen periphery; thus, the luminance of the entire screen can be increased. Furthermore, the uniformity of screen luminance can be improved. Even if the entire light guide plate 12 does not have uniformly high luminance, similar viewing effects can be achieved by merely making several spots have high luminance.

As described above, one of the high-luminance center points (intersections O1) is arranged in each of the nine areas S1c obtained by dividing the area S1 of the light guide plate 12 into three equal sections in both the long side direction and short side direction. This makes it possible to increase the luminance of the entire screen with ease, and allows an improvement in the uniformity of screen luminance.

As described above, the lines that are a distance of H/9 and H/2 from the short sides 12g towards the inside of the light guide plate are lines Lh (lines Lh1 and line Lh2), the lines that are a distance of V/9 and V/2 from the long sides 12f towards the inside of the light guide plate are lines Lv (lines Lv1 and line Lv2), and one of the high-luminance center points (intersections O1) is arranged in each of the nine intersection locations of the three lines Lh and the three lines Lv. Due to this, when the luminance on the intersections O1 is used to calculate the luminance of the display device 1, the luminance of the entire screen can be effectively increased and the uniformity of the luminance of the entire screen can be effectively improved.

As described above, the scattering dots 12e in the areas S1a have a larger diameter (outer shape) than the scattering dots 12e in the area S1b. This allows the density of the scattering dots 12e in the areas S1a to be increased more than the density of the scattering dots 12e in the area S1b with ease.

### Embodiment 2

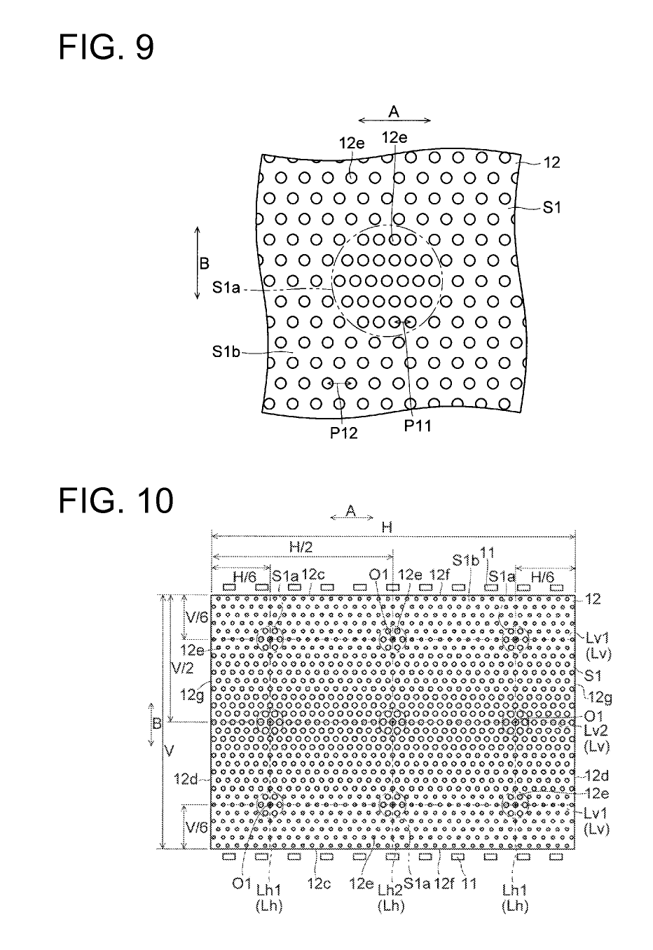

As shown in FIG. 8, in the display device of Embodiment 2 of the present invention, the density of scattering dots 12e in areas S1a is higher than the density of the scattering dots 12e in area S1b, in a manner similar to Embodiment 1 described above. As shown in FIG. 9, in the present embodiment a pitch P11 in the A direction of the scattering dots 12e in the areas S1a is smaller than a pitch P12 in the A direction of the scattering dots 12e in the area S1b. The pitch P11 of the scattering dots 12e in the areas S1a may be approximately 0.5 to 1.5 mm, and the pitch P12 of the scattering dots 12e in the area S1b may be approximately 1.0 to 3.0 mm, for example.

The pitch in the B direction of the scattering dots 12e in the areas S1a may be smaller than the pitch in the B direction of the scattering dots 12e in the area S1b. The pitch in the A direction and the B direction of the scattering dots 12e in the areas S1a may be smaller than the pitch in the A direction and the B direction of the scattering dots 12e in the area S1b.

Other structures in Embodiment 2 are similar to Embodiment 1 described above.

In the present embodiment, as described above, the scattering dots 12e in the areas S1a are arranged at a smaller pitch than the scattering dots 12e in the area S1b. This allows the density of the scattering dots 12e in the areas S1a to be increased more than the density of the scattering dots 12e in the area S1b with ease.

Other effects in Embodiment 2 are similar to Embodiment 1 described above.

### Embodiment 3

As shown in FIG. 10, in the display device of Embodiment 3 of the present invention, lines that are a distance of H/6 from short sides 12g towards the inside of the light guide plate are lines Lh1, the lines that are a distance of V/6 from the long sides 12f towards the inside of the light guide plate are lines Lv1, and prescribed areas that respectively have one of nine intersections O1 (high-luminance center points) of the three lines Lh (two lines Lh1 and line Lh2) and three lines Lv (two lines Lv1 and line Lv2) as the center thereof are areas S1a. The density of scattering dots 12e in the areas S1a is higher than the density of the scattering dots 12e in an area S1b, in a manner similar to Embodiment 1 described above, for example. The density of the scattering dots 12e may be made high in a manner similar to Embodiment 2.

Other structures and effects in Embodiment 3 are similar to Embodiments 1 and 2 described above.

The presently disclosed embodiments are wholly illustrative and not to be construed as limiting. The scope of the present invention is shown in the claims and not the embodiments described above, and in addition, all modifications within the equivalent meaning and scope of the claims are included.

In the respective embodiments above, examples were shown of a display panel applied to a liquid crystal display panel, but the present invention is not limited thereto, and may be applied to a display panel other than a liquid crystal display panel, for example.

In the respective embodiments above, a backlight device that illuminates a display panel was explained as one example of an illumination device, but the present invention is not limited thereto, and can also be applied to an illumination device that illuminates a member to be illuminated other than a display panel.

In the respective embodiments above, an example was shown in which a plurality of light sources are arranged in parallel along two edges of the light guide plate facing each other, but the present invention is not limited thereto, and the plurality of light sources may be arranged in parallel along one edge or along four edges of the light guide plate.

In the respective embodiments above, an example was shown in which LEDs are used as the light sources, but the present invention is not limited thereto. The light sources may be cold cathode fluorescent lamps or the like, for example.

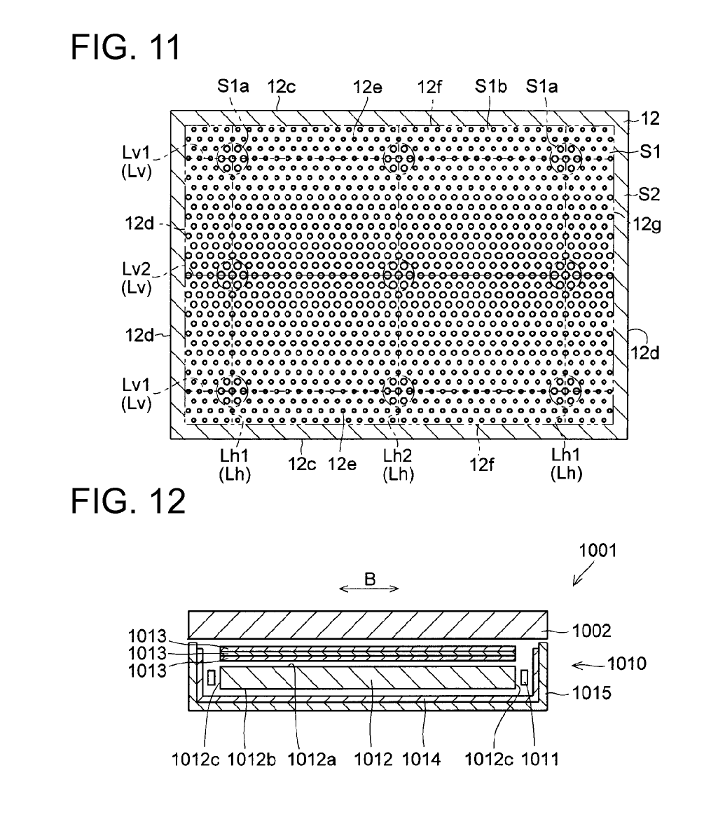

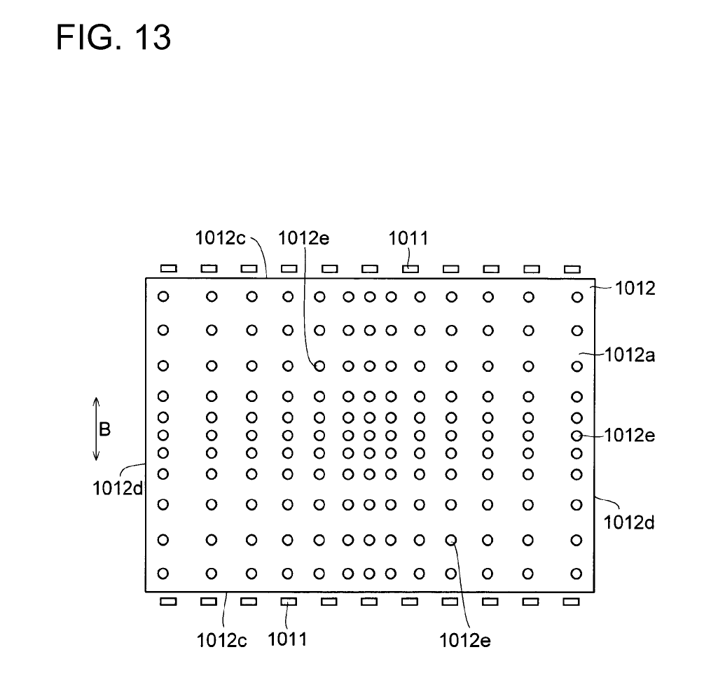

In the respective embodiments above, the entire light guide plate 12 was described as the area S1 (the area corresponding to the display area 2a of the display panel 2), but the present invention is not limited thereto, and the light guide plate 12 may be configured as shown in the modification example of the present invention in FIG. 11, for example. In other words, the light guide plate 12 may be formed so as to include the area S1 corresponding to the display area 2a of the display panel 2 and an area S2 arranged outside the area S1. The hatching area in FIG. 11 is the area S2. In FIG. 11, the scattering dots 12e are formed only in area S1 and are not formed in area S2, but the scattering dots 12e may be formed in both the area S1 and the area S2.

Configurations obtained by appropriately combining the techniques disclosed in different embodiments and the modification example of the present invention are included in the technical scope of the present invention.

### DESCRIPTION OF REFERENCE CHARACTERS

1 display device

2 display panel (member to be illuminated)

2a display area

10 illumination device

11 light source

12 light guide plate

12a light-exiting surface

12b rear surface

12c light-receiving side face

12e scattering dot

12f long side

12g short side

Lh, Lh1, Lh2 line (first line)

Lv, Lv1, Lv2 line (second line)

O1 intersection (high-luminance center point)

P1, P11, P12 pitch

S1 area (area corresponding to display area)

S1a area (first area)

S1b area (second area)

S1c area

1. An illumination device, comprising:
a light source; and
a light guide plate having a light-receiving side face on which light from the light source is radiated, a light-exiting surface where light exits towards a member to be illuminated, and a rear surface opposite to the light-exiting surface,
wherein a plurality of scattering dots are distributed on the light-exiting surface or the rear surface of the light guide plate, the scattering dots scattering light that has entered the light-receiving side face and the light exiting from the light-exiting surface,
wherein a plurality of high-luminance center points are defined in a matrix at prescribed intervals on the light guide plate,
wherein the light-exiting surface or the rear surface of the light guide plate has first areas having one of the high-luminance center points at a center thereof and a second area that includes all areas except the first areas, and
wherein a density of the scattering dots in the first areas is higher than a density of the scattering dots in the second area.

2. The illumination device according to claim 1,
wherein an area of the light guide plate corresponding to a display area of the member to be illuminated has two long sides opposite to each other and two short sides opposite to each other, and
wherein the area of the light guide plate corresponding to the display area is evenly divided into three sections in both a long side direction and a short side direction of the light guide plate to form nine areas, one of the high-luminance center points being disposed in each of these areas.

3. The illumination device according to claim 2,
wherein the high-luminance center points are respectively located at intersection locations of three first lines and three second lines,
wherein a length of the long sides of the light guide plate is H and a length of the short sides of the light guide plate is V,
wherein the first lines are virtual vertical lines that are H/n from the short sides of the light guide plate towards an inside thereof,
wherein the second lines are virtual horizontal lines that are V/n from the long sides of the light guide plate towards the inside thereof, and
wherein n is 2, 6, or 9.

4. The illumination device according to claim 1, wherein the scattering dots in the first areas have a larger outer shape than the scattering dots in the second area.

5. The illumination device according to claim 1, wherein the scattering dots in the first areas are arranged at a smaller pitch than the scattering dots in the second area.

6. The illumination device according to claim 1, wherein the scattering dots include recesses and protrusions formed in the light-exiting surface or the rear surface of the light guide plate.

7. The illumination device according to claim 1, wherein the scattering dots include a reflective layer disposed on the rear surface of the light guide plate.

8. The illumination device according to claim 4, wherein the scattering dots in the first areas have a diameter that is less than or equal to three times a diameter of each of the scattering dots in the second area.

9. A display device, comprising:
the illumination device according to claim 1; and
a display panel illuminated by the illumination device.
